(19) United States
(12) Patent Application Publication
(10) Pub. No.: US 2004/0185843 A1
(43) Pub. Date: Sep. 23, 2004

(54) Remote controlled industrial equipment

(76) Inventors: Wolfgang Bredow, Niefern-Oschelbronn (DE); Thomas Burchard, Pforzheim (DE); Thomas Haug, Olbronn (DE)

Correspondence Address: RABIN & Berdo, PC, 1101 14TH STREET, NW, SUITE 500, WASHINGTON, DC, 20005, US

(21) Appl. No.: 10/801,527

(22) Filed: Mar. 17, 2004

(30) Foreign Application Priority Data
Mar. 18, 2003 (DE) 103 11 836.5

(51) Int. Cl. H04Q 11/00

(52) U.S. Cl. 455/420

(57) ABSTRACT

A remote controlled industrial equipment, e.g., a construction unit with at least one transmitter, which includes at least a second receiver that is operable parallel to a first receiver. The receivers are arranged with parts of the industrial equipment widely displaced apart from one another such that a control connection from the transmitter to at least one of the receivers can be established for the purpose of converting control signals of the transmitter into working movements of the industrial equipment. The receivers can therefore establish a continuous control connection up to the respective receiver that finally controls the working units of the industrial equipment, whereby simple and safe control remains ensured even under unfavourable external conditions.

### CROSS REFERENCE TO RELATED APPLICATIONS

This application claims priority under 35 USC Section 119, of German Application No. 103 11 836.5, filed on Mar. 18, 2003, the subject matter of which is incorporated herein by reference.

### BACKGROUND OF THE INVENTION

The invention relates to remote controlled industrial equipment, such as a crane, having working units of which the movements can be controlled by a transmitter.

Such industrial equipment often comprises very large construction machines, and a distance between the working units and a receiver that controls the working units, on the one hand, and an actual working section of the equipment, such as a crane shovel or a delivery pipe of a concrete pump, on the other hand, can be far apart. Depending upon the range of the transmitter and construction conditions, such as partition walls, window openings in new buildings and requisite control precision, the operator monitoring and controlling the working process may need to be in visual contact with the work area of the industrial equipment. As such, the operator may need to locate himself and the transmitter in a position such that radio contact to the receiver, which is generally located near the respective working units of the industrial equipment, cannot or can no longer be consistently established, thus causing problems in the working process and especially leading to an increase in safety risks.

### SUMMARY OF THE INVENTION

It is hence an object of the invention to improve such a remote controlled industrial equipment, so that easy and safe control remains ensured even under unfavourable external conditions.

This problem is inventively solved by providing at least a second receiver that is operable parallel to the first receiver, whereby the receivers are arranged with parts of the industrial equipment widely displaced from one another, such that a control connection from the transmitter to at least one of the receivers can be established for the purpose of converting control signals of the transmitter into working movements of the industrial equipment

A basic aspect of the invention is that providing at least two receivers allows the establishment of a continuous control link up to the respective receiver that finally triggers the controller for the working unit of the industrial equipment.

A simple exemplary aspect of the invention provides for a link at least between two receivers using a control line that, for instance, extends from a cross-arm of the industrial equipment up to the receiver located in its main working area. This aspect is especially a very simple and reliable solution, if, due to construction conditions, radio connections between remotely located sections of the industrial equipment are probably shielded.

The receivers may also be provided with appropriate transmitters (transceivers) for generating a feedback radio connection or for supplying a feedback line if a control line is used.

### BRIEF DESCRIPTION OF THE DRAWINGS

FIGS. 1A and 1B are perspective views showing various aspects of the invention.

### DETAILED DESCRIPTION OF THE INVENTION

The basic configuration of such system parts is known, so that two preferred embodiments are explained in the drawings.

In the two exemplary embodiments, the industrial equipment 10 is illustrated as being a concrete pump mounted on a lorry, and having a plurality of articulated-joint sections 10A . . . 10D. The working area lies above a structure to be either worked on or filled with concrete. However, it will be appreciated that the concepts of the present invention are applicable with other types of industrial equipment, and with different arrangements of the working area.

A first portable, operator-controlled transmitter or transceiver TR1 controls the intended working units on the lorry. Furthermore, a second receiver or transceiver TR2 and a third receiver or transceiver TR3 are provided. The second transceiver TR2 is installed near the articulated-joint arm and the pump's control unit, and the third transceiver TR3 is located in the end section of the articulated-joint arm. In this illustrated exemplary embodiment, transceivers TR2 and TR3 are connected together via a control line 30. Second transceiver TR2 receives the control signals required for controlling the working units either directly from the first transceiver TR1, which is controlled by the operator, or indirectly from the first transceiver TR1 via the third transceiver TR3. Second transceiver TR2 conveys the control signal to the control unit. For proper operation, transceivers TR1 and TR3 are connected in parallel with respect to the second transceiver TR2. Likewise, third transceiver TR3 may receive the control signals for controlling the working units either directly from first transceiver TR1, or indirectly from the first transceiver TR1 via the second transceiver TR2.

This aspect of the invention results in a spectrum of control possibilities or standing places for the operator with the first transceiver TR1, which can be chosen depending upon the type of work.

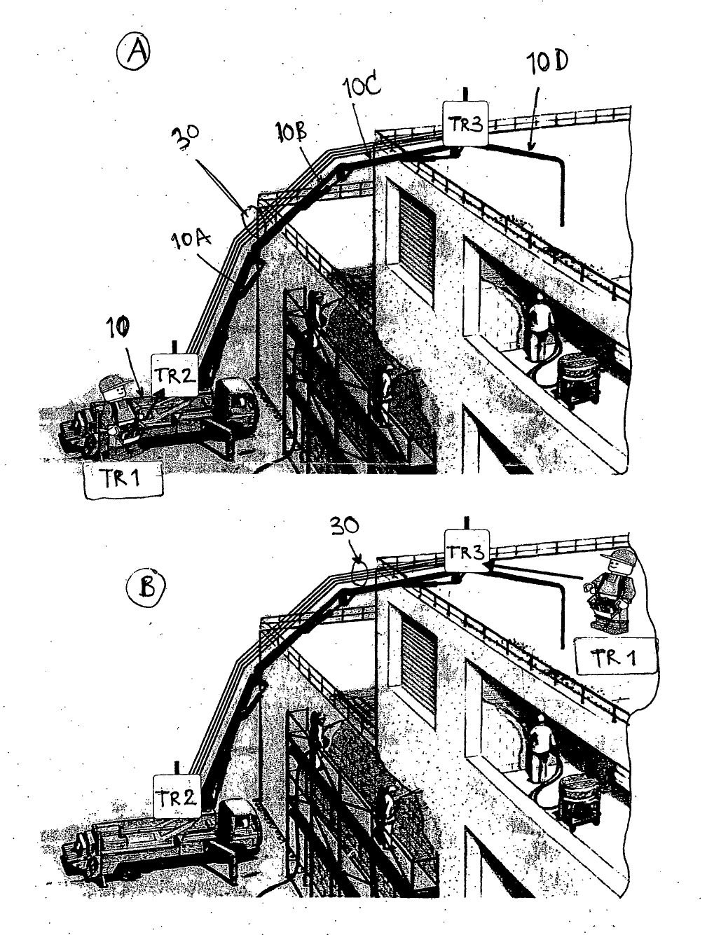

For example, in the arrangement shown in FIG. 1A, the operator with transceiver TR1 is situated near transceiver TR2 so that the standard radio control of the articulated-joint arms of the concrete pump can be implemented. A cable can also be connected via the articulated-joint arms to the working unit at the end of the articulated-joint arms.

In the arrangement shown in FIG. 1B, the operator is situated near the working end (i.e., the delivery pipe of the concrete pump). The operator controls the third transceiver TR3, which is mounted at the end of the articulated-joint arms, using the first transceiver TR1, because direct radio contact to the second transceiver TR2 for controlling the equipment cannot reliably come into effect due to common construction conditions as illustrated. The third transceiver TR3 conveys the control signals received from the first transceiver TR1 via the control line 30, and/or using additional radio contact, to the second transceiver TR2, so that the operator can take control without establishing direct radio contact from the first transceiver TR1 to the second transceiver TR2.

This aspect of the invention may be implemented with little effort, and the number of receivers or transceivers may be adjusted to the current conditions, especially because a certain number of idle lines are generally provided along the articulated-joint arms of the concrete pump, which can be used as a control or feedback line. In the case of the exemplary aspects of the transmitter/receiver as a transceiver described above, bidirectional data traffic is possible.

Furthermore, together with control information or at periodical intervals, transceiver TR2 may receive information about the identity and, if necessary, about the location of the other two transceivers TR1 or TR3. From this additional information based upon stored pre-settings, the working unit's control unit can then modify, activate or deactivate certain operational procedures that are executed by the equipment on the lorry in order to improve the quality or safety of the types of work. Thus, for example, the swivelling motion of the articulated-joint arms can be limited, for instance, by a certain distance or height of the concrete pump delivery pipe and thus by a specific position of the transceiver TR3 and/or TR1, as depicted in the exemplary embodiment.

The exemplary aspect of the transmitter/receiver (as a transceiver) enables the types of work to be programmed and optimised, based on the application inside the object (for instance a building) in question.

What is claimed is:

1. A remote controlled industrial equipment, comprising:
at least one transmitter;
at least one first receiver; and
at least one second receiver that is operable parallel to the first receiver, the receivers being arranged with parts of the industrial equipment widely displaced from one another, such that a control connection from the transmitter to at least one of the receivers can be established for the purpose of converting control signals of the transmitter into working movements of the industrial equipment.

2. The remote controlled industrial equipment according to claim 1, wherein the first and second receiver are connected together via a permanently installed control line on the industrial equipment.

3. The remote controlled industrial equipment according to claim 1, wherein the first and second receivers are at least partially configured as transceivers for establishing a radio feedback channel.

4. The remote controlled industrial equipment according to claim 1, wherein a control connection between the transmitter and the respective receivers, to a controller of a working unit of the industrial equipment, which facilitates a conversion of the control signals into the working movements, contains additional information about an identity and/or a location of the transmitter/receivers for influencing a type and/or a scope of the working movements.

5. A remote controlled industrial equipment, comprising:
at least one transmitter;
at least one first receiver; and
at least one second receiver that is operable parallel to the first receiver, the first and second receivers being respectively arranged in different locations and associated with different parts of the industrial equipment widely displaced from one another, such that when a control connection between the transmitter and the first receiver can not be established, a control connection from the transmitter to the second receiver can be established for converting control signals of the transmitter into working movements of the industrial equipment, and such that when the control connection between the transmitter and the second receiver can not be established, the control connection from the transmitter to the first receiver can be established for converting the control signals of the transmitter into the working movements of the industrial equipment.

6. The remote controlled industrial equipment according to claim 5, wherein the transmitter is portable.

7. The remote controlled industrial equipment according to claim 5, wherein at least one of the receivers and the transmitter comprises a transceiver.
